(19) United States
(12) Patent Application Publication
(10) Pub. No.: US 2016/0044137 A1
(43) Pub. Date: Feb. 11, 2016

(54) INFORMATION PROCESSING TERMINAL AND CONTROL METHOD THEREFOR

(71) Applicant: CANON KABUSHIKI KAISHA, Tokyo (JP)

(72) Inventor: Toshiyuki Nakazawa, Tokyo (JP)

(21) Appl. No.: 14/819,215

(22) Filed: Aug. 5, 2015

(30) Foreign Application Priority Data
Aug. 8, 2014 (JP) 2014-162997

(51) Int. Cl. H04L 29/08; H04L 7/00

(52) U.S. Cl. CPC H04L 67/34; H04L 67/02; H04L 67/32; H04L 7/0079

(57) ABSTRACT

In order to execute synchronization processing, a method for a web browser having a function for storing data requested from a web application in a predetermined region of a storage unit as local data includes transmitting at least a part of stored local data to a storage service on a network different from the web application, and updating the local data by using data acquired from the storage service.

### BACKGROUND OF THE INVENTION

1. Field of the Invention

The present invention relates to a technique for providing a web browser on which a data storage system of a web browser in Hyper Text Markup Language (HTML) 5 is mounted.

2. Description of the Related Art

The HTML 5 has been extended in various aspects along with the advancement in function of web applications. In particular, with popularization of mobile terminals such as smartphones and tablet terminals, a function for operating the web application offline has been extended in various ways.

An application cache function for caching a file existing in a web server into a storage region for a web browser in an information processing terminal can be given as one example. In addition, a function such as “WebStorage” or “IndexedDB” for storing data in a storage region for the web browser can be given as another example. Further, a function known as “FileSystem application program interface (API)” for operating a file within a storage region for the web browser can be given as still another example. Furthermore, there is also provided a system for managing a network connection state (i.e., on-line/off-line) of the information processing terminal on which the web browser operates to make the connection state referable through the web application, and notifying changes in the connection state to the web application.

For example, as a conventional technique, Japanese Patent Application Laid-Open No. 2008-097201 discusses a system for sharing data between web browsers. According to the technique described in Japanese Patent Application Laid-Open No. 2008-097201, information including user identification information and uniform resource locator (URL) information are transmitted to a server. The server stores the received data in a database in association with the user identification information. When a user refers to a bookmark, a mobile terminal transmits information including the user identification information to the server, so that the server transmits the URL information stored in the database to the mobile terminal to realize a system for sharing the bookmark.

The above-described function for storing data within the web browser is used in order to realize the web application by storing the user's data in the web browser without using a data storage function of the server that provides the web application. For example, the web application stores the data input by the user in a storage region for the web browser. Then, the data stored in that storage region is used when the same web application is opened next time, so that the web browser can operate as if the data is stored in the server that provides the web application.

However, the technique discussed in Japanese Patent Application Laid-Open No. 2008-097201 merely describes a system for sharing the registration information (i.e., bookmarks) of the web browser. In other words, a system for sharing data relating to the operation input to the web application, which is stored in the storage region of the web browser through the above-described data storage function, with another web browser is not taken into consideration. Therefore, for example, even if the same web application is used in a personal computer (PC) and a mobile terminal, the user cannot share the data respectively input to the web application through the PC and the mobile terminal. Further, when the user replaces the PC or the mobile terminal with new one, the data input to the web application through the PC or the mobile terminal via the web browser before replacement cannot be transferred to a new PC or a new mobile terminal.

### SUMMARY OF THE INVENTION

The present invention is directed to a system capable of sharing data, which is input into a web application and stored in a storage region for a web browser, with different web browsers.

According to an aspect of the present invention, an information processing terminal on which a web browser operates, wherein the web browser has a function for storing data requested from a web application as local data, the information processing terminal includes a transmission unit configured to transmit at least a part of stored local data to a storage service on a network different from the web application, and an update unit configured to update the local data by using data acquired from the storage service, wherein the storage service manages the data transmitted from the transmission unit in association with account information and information of the web application acquired via the web browser.

Further features of the present invention will become apparent from the following description of exemplary embodiments with reference to the attached drawings.

### BRIEF DESCRIPTION OF THE DRAWINGS

FIG. 1 is a block diagram illustrating an example of a module configuration of a web browser.

FIG. 2 is a block diagram illustrating an example of a hardware configuration of a mobile terminal.

FIG. 3 is a block diagram illustrating an example of a hardware configuration of a personal computer (PC).

FIG. 4 is a diagram illustrating an example of a system configuration according to a first exemplary embodiment.

FIGS. 5A and 5B are diagrams illustrating examples of screens that are to be displayed when a function provided by a storage server is used.

FIG. 6 is a flowchart illustrating synchronization processing in an information processing terminal on which the web browser operates, which is to be executed when a web page is loaded.

FIGS. 7A and 7B are flowcharts illustrating flows of processing that are to be executed when the web browser is executing a web application.

FIG. 8 is a flowchart illustrating synchronization processing called in step S703 of FIGS. 7A and 7B.

FIG. 9 is a diagram illustrating an example of a warning screen provided by the web browser when the synchronization processing is executed.

FIG. 10 is a diagram illustrating an example of a system configuration according to a second exemplary embodiment.

FIG. 11 is a sequence diagram illustrating processing executed at a web page-loading period, according to the second exemplary embodiment.

FIG. 12 is a sequence diagram illustrating processing that is to be executed when the web application is being executed according to the second exemplary embodiment.

FIG. 13 is a flowchart illustrating synchronization processing that is to be executed when the web application is executed according to the second exemplary embodiment.

FIG. 14 is a diagram illustrating an example of a warning screen according to the second exemplary embodiment which is to be displayed when an extended function module accesses local data in the web browser for a first time.

FIGS. 15A and 15B are diagrams illustrating examples of screens for setting a function for synchronizing data, which is provided by the web browser.

FIG. 16 is a flowchart illustrating synchronization processing executed when a web page is loaded according to the second exemplary embodiment.

FIG. 17 is a diagram illustrating a warning screen provided by the web browser according to the second exemplary embodiment.

### DESCRIPTION OF THE EMBODIMENTS

Hereinafter, exemplary embodiments of the present invention will be described with reference to the appended drawings.

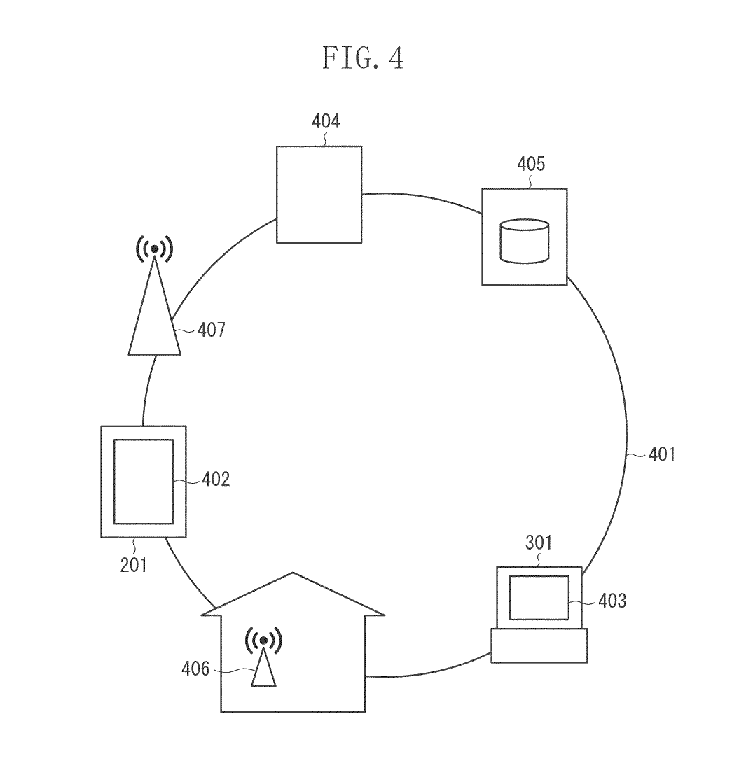

FIG. 4 is a diagram illustrating an example of constituent elements within a system according to a first exemplary embodiment.

A web browser 402 operates on a mobile terminal 201. A web browser 403 operates on a personal computer (PC) 301. An internet 401 serves as a network.

The mobile terminal 201 connects to the internet 401 via a base station 407 for mobile communication in, for example, Third-generation (3G) or Long Term Evolution (LTE). An access point 406 serves as a wireless fidelity (Wi-Fi) access point. The mobile terminal 201 connects to the internet 401 via the access point 406 in order to perform Wi-Fi communication. The PC 301 connects to the internet 401 via a router (not illustrated).

An application server 404 provides a web application, whereas a storage server 405 provides a storage service function. The web browsers 402 and 403 can connect to the application server 404 and the storage server 405 on the network. In the present exemplary embodiment, a development vendor of the web browsers 402 and 403 and a provider of the storage service provided through the storage server 405 are assumed to be the same or cooperate with each other. More specifically, it is possible to realize simple authentication in which the account information registered in the web browser 402 is directly used as the account information to the storage service. Further, the user can assign only a type of data supported by the storage service or the web browser 402 or 403 as a target of the below-described synchronization processing without making any intentional effort.

Further, in addition to the mobile terminal 201 and the PC 301, the present invention is also applicable to any devices only if the below-described function provided by the web browser 402 or 403 can be executed. More specifically, a tablet terminal, a smartphone, a car navigation system, a camera, a wearable terminal in a form of eyeglasses or a watch, and a home appliance such as a television or a refrigerator are given as examples of the devices to which the present invention is applicable. In the present exemplary embodiment, the above-described devices are collectively referred to as information processing terminals.

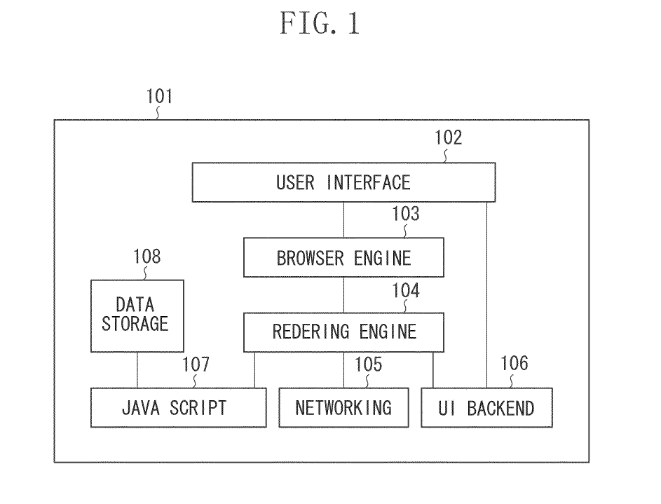

FIG. 1 is a block diagram illustrating an example of a module configuration provided as functions of a web browser 101. The web browsers 402 and 403 illustrated in FIG. 4 include a configuration illustrated in FIG. 1.

A user interface (UI) 102 provides most of the components of a browser screen such as an address bar and return/forward buttons, i.e., except for a main window for displaying a page. A browser engine 103 organizes the processing executed between the UI 102 and a rendering engine 104. The rendering engine 104 renders and displays a requested content. For example, when the requested content is Hyper Text Markup Language (HTML), the rendering engine 104 analyzes the HTML and the cascading style sheets (CSS) to display the analyzed content on a screen. A networking 105 is used to call a network by sending a request such as a hypertext transfer protocol (HTTP) request. A UI backend 106 is used to render a basic widget such as a combo box or a window. The UI backend 106 provides a non-platform specific general interface, and calls a rendering method that is specific to an operating system (OS) underneath thereof. A JavaScript (registered mark) (JS) interpreter 107 is used to analyze and execute a JavaScript (registered mark) code. The JS interpreter 107 is configured of a non-platform specific JavaScript (registered mark) execution unit and a unit for accessing the network information including positional information and on-line information. A data storage unit 108 stores data in a storage region within a below-described storage unit 205 provided for the web browser 101. In addition to the information such as cookie, local storage data that supports the extended function of the HTML 5 (e.g., data such as LocalStorage, FileSystem, and IndexedDB) and application cache are assumed to be the data as the storage targets.

In the present invention, an example for providing a function module illustrated in FIG. 1 through the web browser 101 will be described. However, similar function modules may be provided by the OS of the information processing terminal, or may be realized through a cooperative operation of the OS and the web browser 101. Furthermore, a platform for uniquely operating the function module may be provided on the OS to realize the similar function modules.

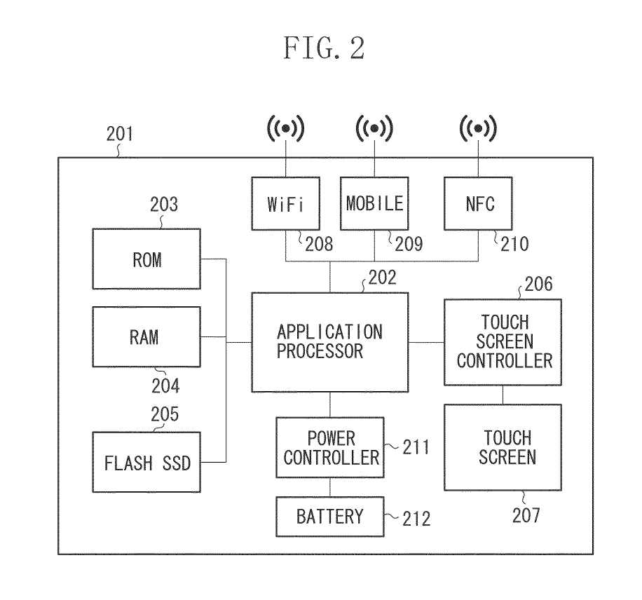

FIG. 2 is a block diagram illustrating a hardware configuration of the mobile terminal 201 on which the web browser 101 operates. The mobile terminal 201 includes an application processor (AP) 202, a read only memory (ROM) 203, a random access memory (RAM) 204, and a storage unit 205.

The AP 202 executes software stored in the ROM 203 or the storage unit 205 to collectively control respective units connected to the AP 202. The RAM 204 functions as a main memory or a work area of the AP 202. The storage unit 205 is configured of a flash memory or the like. Various application programs such as an operating system and a web browser, database data, and a user file are stored in the storage unit 205. The mobile terminal 201 further includes a touch screen controller 206 for controlling a touch screen 207 connected to the touch screen controller 206. Further, the mobile terminal 201 includes a wireless local area network (LAN) control unit 208, a mobile communication control unit 209, and a near field communication (NFC) control unit 210, which respectively control wireless LAN communication, mobile communication, and near field communication. The mobile terminal 201 further includes a power controller 211. The power controller 211 executes charging control of a battery 212 and manages the remaining battery level thereof.

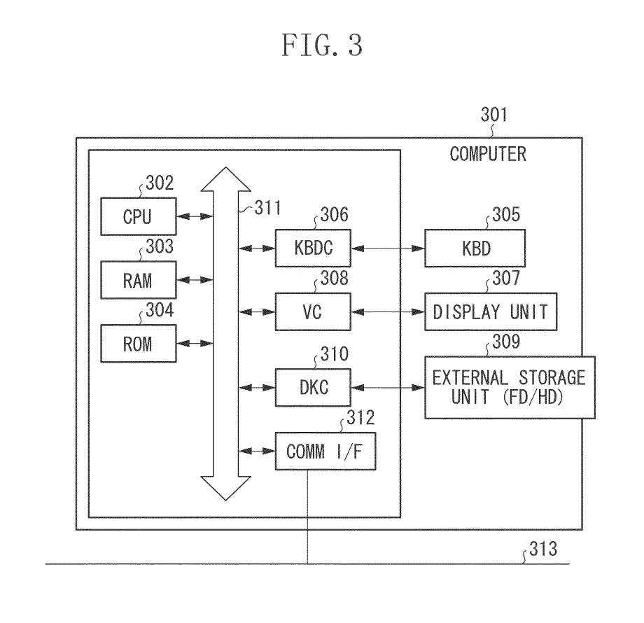

FIG. 3 is a block diagram illustrating a hardware configuration of the PC 301. In FIG. 3, the PC 301 includes a central processing unit (CPU) 302, a RAM 303, a ROM 304, and an external storage unit 309.

The CPU 302 executes software stored in the ROM 304 or the external storage unit 309 or software downloaded through a network 313 in order to collectively control respective units connected to a system bus 311. The RAM 303 functions as a main memory or a work area for the CPU 302. The external storage unit 309 includes a hard disk (HD), a floppy disk (FD) (registered mark), or the like. Various application programs such as a boot program, an operating system, an authentication server, an authentication client, and a web browser, as well as database data, and a user file are stored in the external storage unit 309. The PC 301 further includes a keyboard controller (KBDC) 306 for transmitting information input through a keyboard (KBD) 305 or a pointing device (not illustrated) to the CPU 302. A video controller (VC) 308 executes display control of a display unit 307 configured of a cathode ray-tube (CRT) display or a liquid crystal display (LCD). A disk controller (DKC) 310 controls the access to the external storage unit 309. The PC 301 is connected to a network 313 via a communication interface (COMM I/F) 312. Although it is not illustrated in FIG. 3, the network 313 is connected to the internet 401 via a router.

Further, a computer constituting the application server 404 or the storage server 405 also includes similar hardware configurations such as a CPU, a RAM, a ROM, a disk controller, an external storage unit, and a communication I/F as illustrated in FIG. 3. A CPU of the application server 404 executes a predetermined program for providing a web application or a web server function. Further, a CPU of the storage server 405 executes a predetermined program for providing a storage service or a web server function.

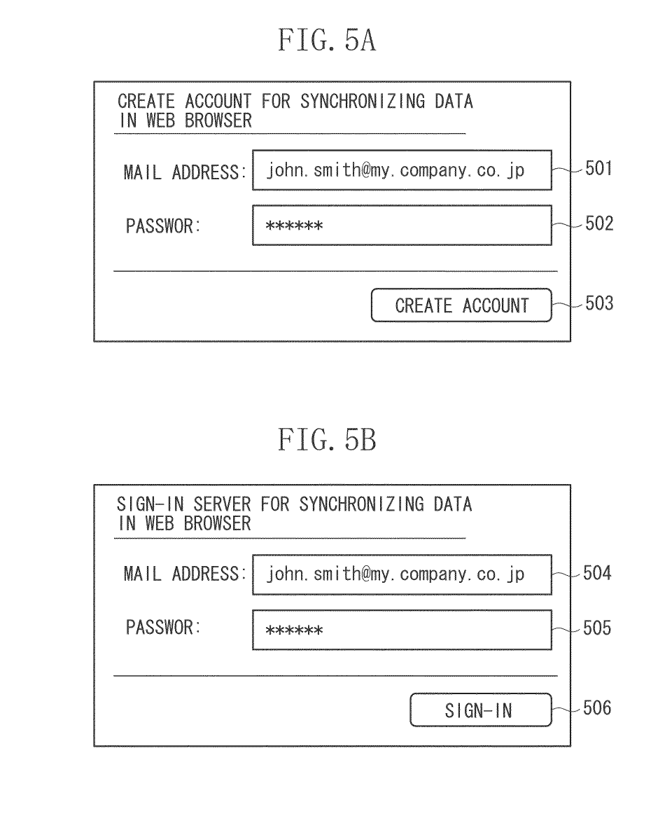

FIGS. 5A and 5B are diagrams illustrating examples of the screens that are to be displayed when a storage service function provided by the storage server 405 is used. In order to save (synchronize) the data stored in the data storage unit 108 of the web browser 101 in the storage server 405, a user needs a user account for accessing the storage server 405.

FIG. 5A illustrates an example of a screen for creating a user account. This screen is displayed on a screen of the web browser 101 when the user accesses a URL for account creation provided within the storage server 405 from the web browser 101. Alternatively, if the web browser 101 and the storage server 405 cooperate with each other, the screen is displayed when the user selects a setting menu of the web browser 101.

A mail address serving as a user's identifier can be input into a text box 501. A password for user authentication can be input into a text box 502. When the web browser 101 detects that a “CREATE ACCOUNT” button 503 is pressed, the web browser 101 transmits an account creation request to the storage server 405 together with the mail address and the password input in the text boxes 501 and 502. If it is confirmed that a user having a same mail address as the received mail address does not exist, the storage server 405 creates a requested account within the storage server 405. Alternatively, the storage server 405 transmits a mail including a URL for validating the requested account to the mail address input thereto.

FIG. 5B illustrates an example of a screen for setting the account information to the web browser 101. The web browser 101 accesses the storage server 405 by using the account information.

A mail address serving as a user's identifier is input into a text box 504, whereas a password for user authentication is input into a text box 505. When the web browser 101 detects that a “SIGN-IN” button 506 is pressed, the web browser 101 transmits the information input in the text boxes 504 and 505 to the storage server 405 and receives a result of account authentication. If the account information is correct, the web browser 101 stores the account information (i.e., mail address and password) in the storage unit 205 or 309. If the account information is incorrect, the web browser 101 displays a notification regarding the incorrect information and displays a screen for inputting the account information illustrated in FIG. 5B again.

Thereafter, when the web browser 101 synchronizes the data within the data storage unit 108 with data within the storage server 405, the web browser 101 uses the stored account information to access the storage server 405.

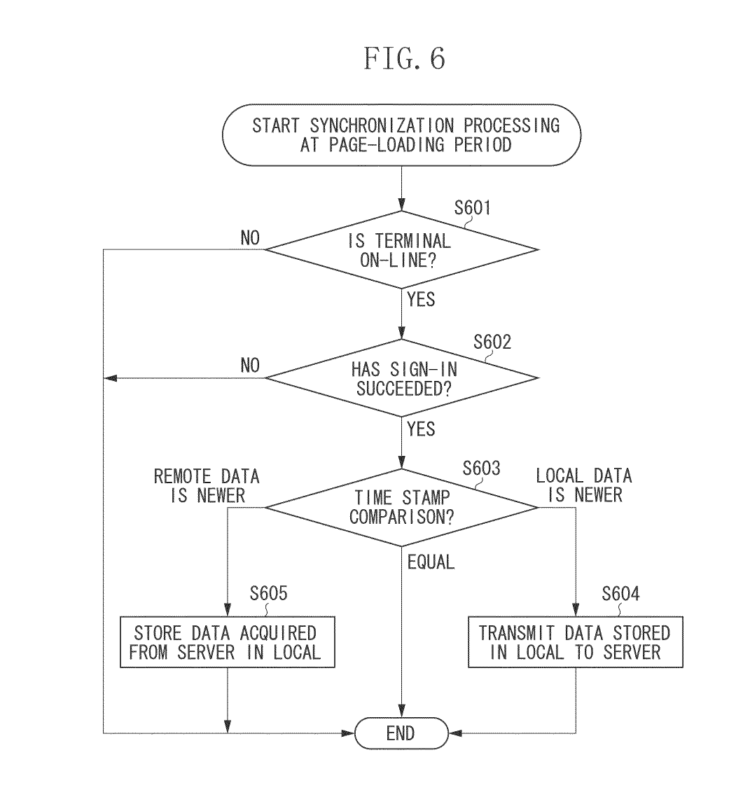

FIG. 6 is a flowchart illustrating synchronization processing that is to be executed in the information processing terminal such as the mobile terminal 201 on which the web browser 101 operates when a web page is loaded. The processing is realized when the AP 202 or the CPU 302 reads and executes the web browser 101 (i.e., program).

In step S601, the web browser 101 checks a current state of network connection. If the web browser 101 checks and determines that the information processing terminal is connected to the network (i.e., on-line state) (YES in step S601), the processing proceeds to step S602. If the web browser 101 determines that the information processing terminal is not connected to the application server 404 or the storage server 405 via the network (i.e., off-line state) (NO in step S601), the web browser 101 ends the synchronization processing. In addition, as described above, even if the information processing terminal is the off-line state, the web browser 101 can execute the web application by using local storage data or application cache.

In step S602, the web browser 101 determines whether the access to the storage server 405 has succeeded. Specifically, the web browser 101 checks the state of sign-in with respect to the storage server 405 using the account information set in the screen of FIG. 5B. If the account information is not stored or the access to the storage server 405 using the stored account information has failed (NO in step S602), the web browser 101 ends the synchronization processing. On the other hand, if the access to the storage server 405 using the stored account information has succeeded (YES in step S602), the processing proceeds to step S603.

In addition, the account information and data associated with the URL managed by the storage server 405 are referred to as “remote data”. At least a part of the local storage data or the application cache that supports the web application indicated by the URL, which is regarded as a storage target of the data storage unit 108 of the web browser 101, is included in the remote data. In addition to the account information and the URL, the storage server 405 can manage the data according to a so-called “origin”, i.e., a combination of a protocol, a host name, and a port. On the other hand, data stored in the storage region for the web browser 101 of the information processing terminal, transmitted to the storage server 405 in order to execute the synchronization processing, is referred to as “local data”. Similar to the remote data, at least a part of the local storage data or the application cache that is regarded as the storage target of the data storage unit 108 of the web browser 101 is included in the local data.

In step S603, the web browser 101 compares the latest update date and time of the remote data with that of the local data to execute comparison processing of time stamps. In order to execute the comparison processing, the web browser 101 acquires, from the storage server 405, the information relating to the latest update date and time of the remote data based on the account information and the specified URL. If the latest update date and time of the remote data is the same as that of the local data or neither the remote data nor the local data exists (“EQAL” in step S603), the web browser 101 ends the synchronization processing. Further, if the latest update date and time of the remote data is newer than that of the local data or the remote data exists but the local data does not exist (“REMOTE DATA IS NEWER” in step S603), the processing proceeds to step S605. Furthermore, if the latest update date and time of the local data is newer than that of the remote data or the local data exists but the remote data does not exist (“LOCAL DATA IS NEWER” in step S603), the processing proceeds to step S604.

In step S605, the web browser 101 updates the local data within the information processing terminal with the remote data. More specifically, the web browser 101 acquires the remote data from the storage server 405 to overwrite and store the acquired data in a predetermined region via the data storage unit 108. Further, the web browser 101 sets the latest update date and time of the local data to be the latest update date and time of the remote data. Thereafter, the web browser 101 ends the synchronization processing.

In step S604, the web browser 101 updates the remote data within the storage server 405 with the local data. More specifically, the web browser 101 transmits the stored local data to the storage server 405. Thereafter, the web browser 101 updates the latest update date and time of the local data with the latest update date and time transmitted from the storage server 405, and ends the synchronization processing. On the other hand, when the storage server 405 receives the data from the information processing terminal via the web browser 101, the storage server 405 checks the account information and the specified URL and overwrites the corresponding remote data with the received data. Then, the storage server 405 sets the latest update date and time of the remote data to be the current time, and returns the latest update date and time of the remote data to the web browser 101.

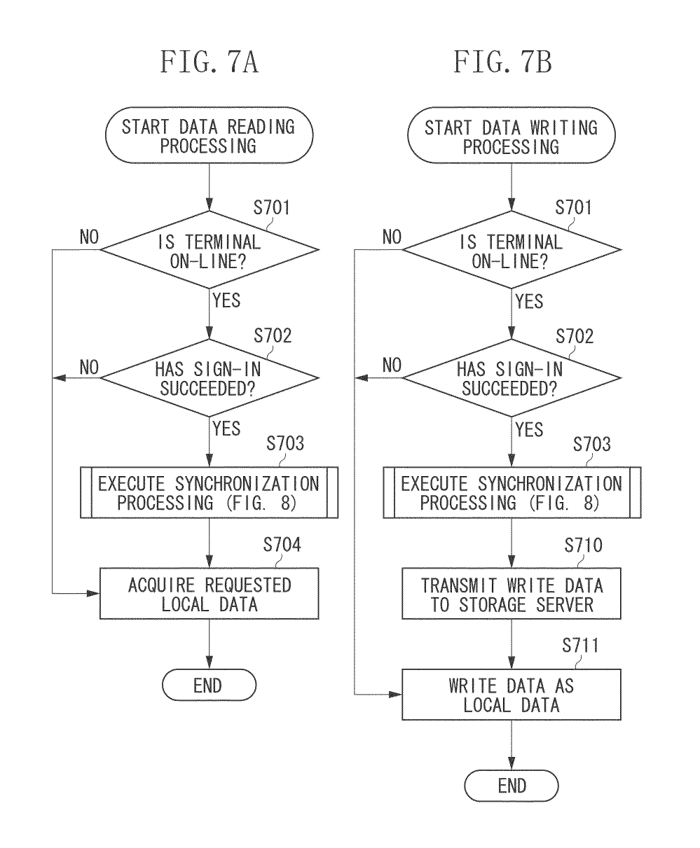

FIGS. 7A and 7B are flowcharts illustrating flows of processing that are to be executed when the web browser 101 is executing the web application.

FIG. 7A is a flowchart illustrating processing that is to be executed when the web application in execution reads the local data from a predetermined region via the data storage unit 108.

The processing in steps S701 and S702 is similar to that in steps S601 and S602 in FIG. 6, and thus detailed description thereof will be omitted. If it is determined that the information processing terminal is the off-line state (NO in step S701) or the information processing terminal cannot access the storage server 405 (NO in step S702), the processing proceeds to step S704. If both of the determination results in steps S701 and S702 are “YES”, the processing proceeds to step S703.

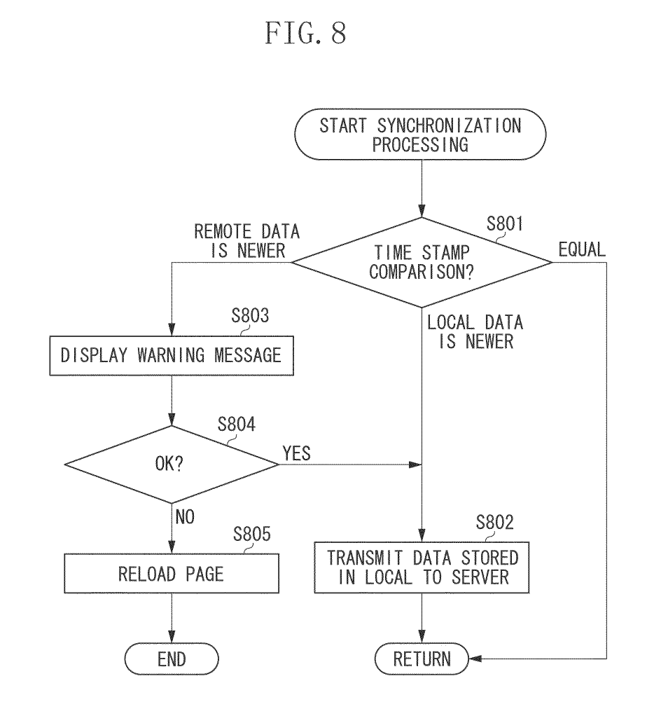

In step S703, the web browser 101 executes the synchronization processing. The synchronization processing will be described below in detail with reference to FIG. 8.

In step S704, the web browser 101 acquires at least a part of the local data (mainly the local storage data) requested from the web application from a predetermined storage region via the data storage unit 108. The web browser 101 provides the acquired data to the web application.

FIG. 7B is a flowchart illustrating processing that is to be executed when the web application in execution writes data in a predetermined region via the data storage unit 108 as the local data. The processing in steps S701 to S703 is similar to that described in FIG. 7A, and thus the description thereof will be omitted. If it is determined that the information processing terminal is the off-line state (NO in step S701) or the information processing terminal cannot access the storage server 405 (NO in step S702), the processing proceeds to step S711.

In step S710, the web browser 101 transmits the write data requested from the web application to the storage server 405 and requests the storage server 405 to execute writing processing of the data. At least a part of the local data (mainly local storage data) will be a target of the writing processing. According to the request of the writing processing, the storage server 405 executes the writing processing of the requested data, and further updates the latest update date and time based on the execution timing of the writing processing. Thereafter, the storage server 405 returns the update date and time to the web browser 101.

In step S711, the web browser 101 writes the write data requested from the web application in a predetermined storage region as the local data via the data storage unit 108. At this time, if the web browser 101 has acquired the latest update date and time from the storage server 405 in step S710, the date and time is updated with that acquired value. On the other hand, if the processing has directly proceeded to step S711 from step S701 or S702, the web browser 101 updates the latest update date and time with the current date and time provided by the information processing terminal.

FIG. 8 is a flowchart illustrating synchronization processing called in step S703 in FIGS. 7A and 7B.

In step S801, the web browser 101 compares the latest update date and time of the remote data to that of the local data to execute comparison processing of time stamps. In order to execute the comparison processing, the web browser 101 acquires, from the storage server 405, the information relating to the latest update date and time of the remote data based on the account information and the URL corresponding to the web application. If the latest update date and time of the remote data is the same as that of the local data or neither of the remote data nor the local data exist (“EQUAL” in step S801), the web browser 101 ends the synchronization processing. Further, if the latest update date and time of the local data is newer than that of the remote data or the local data exists but the remote data does not exist (“LOCAL DATA IS NEWER” in step S801), the processing proceeds to step S802. Further, if the latest update date and time of the remote data is newer than that of the local data or the remote date exists but the local data does not exist (“REMOTE DATA IS NEWER” in step S801), the processing proceeds to step S803.

In step S802, the web browser 101 updates the remote data in the storage server 405 with the local data. More specifically, the web browser 101 transmits the local data to the storage server 405. Thereafter, the web browser 101 updates the latest update date and time of the local data with the latest update date and time transmitted from the storage server 405, and ends the synchronization processing. On the other hand, when the storage server 405 receives the data from the information processing terminal via the web browser 101, the storage server 405 checks the account information and the specified URL and overwrites the corresponding remote data with the received data.

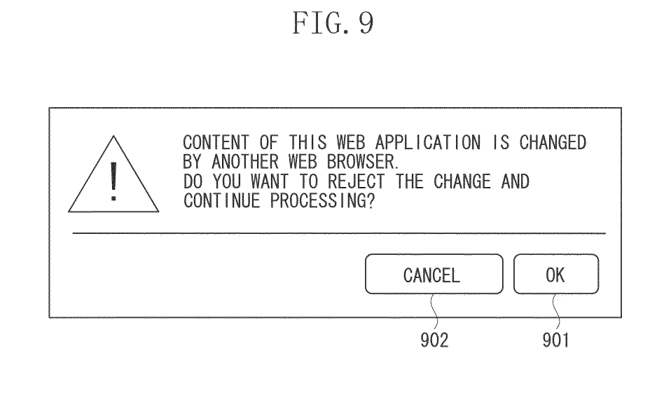

In step S803, the web browser 101 controls the UI 102 to display a warning message (see FIG. 9). A message illustrated in FIG. 9 is displayed in order to notify the user that the local storage data used by the web application has been changed because the same web application has been executed by a web browser operating on another terminal. The display screen illustrated in FIG. 9 further provides the user with an “OK” button 901 for inputting an instruction for employing the local data and a “CANCEL” button 902 for inputting an instruction for employing the remote data that is newer than the local data.

In step S804, the web browser 101 receives a user input and determines whether the “OK” button 901 is pressed. If the “OK” button 901 is pressed (YES in step S804), the processing proceeds to step S802 described above. If the “CANCEL” button 902 is pressed (NO in step S804), the processing proceeds to step S805.

In step S805, the web browser 101 reloads a page provided by the web application, and ends the processing. At this time, the web browser 101 executes the processing illustrated in FIG. 6 after reloading the page. In such a case, because the update date and time of the remote data is newer than that of the local data, the web browser 101 reconfigures the web page after updating the local data with the remote data.

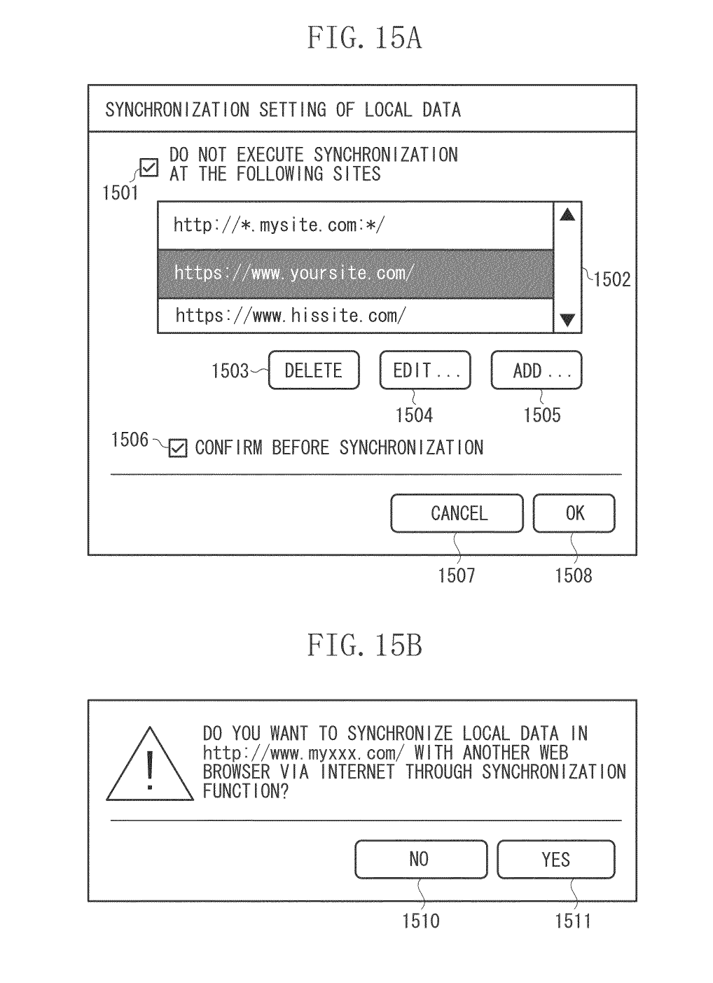

FIGS. 15A and 15B are diagrams illustrating examples of screens for setting a function for synchronizing the data, which is provided by the Web browser 101.

FIG. 15A is an example of a setting screen provided by the web browser 101, relating to a function for synchronizing the data stored in the data storage unit 108.

A checkbox 1501 allows the user to select whether to specify a web site (i.e., web application) that is to be excluded from a target of the synchronization processing. When the checkbox 1501 is unchecked (disabled), the web browser 101 executes the above-described synchronization processing with respect to the storage server 405 on any web sites by using the local data stored in a predetermined region via the data storage unit 108.

On the other hand, if the user checks the checkbox 1501, a list box 1502 and buttons 1503 to 1505 are enabled. The list box 1502 includes a list of web sites for which execution of the currently-specified synchronization processing is restricted. With respect to the web applications starting from the URL (i.e., schema, host, and port) included in the list, the web browser 101 does not execute the above-described synchronization processing using the local data stored in a predetermined region via the data storage unit 108. When the user selects the URL from the list box 1502 to press a “DELETE” button 1503, the selected URL is deleted from the list. When the user selects the URL from the list box 1502 to press an “EDIT” button 1504, a screen (not illustrated) allowing the user to edit the selected URL is opened.

When the web browser 101 detects that an “ADD” button 1505 is pressed, the web browser 101 opens a screen (not illustrated) for newly adding a URL to the list box 1502. An asterisk “*” serving as a wildcard character can be used for the URL registered on the list box 1502. For example, a URL “http://*.mysite.com:*/” corresponds to “http://www.mysite.com/”, and “http://app.mysite.com:8080/”. Based on the above regulations, the URL instructed by the user to add to the list is reflected on the list box 1502.

A checkbox 1506 allows the user to set whether to display a confirmation screen for confirming necessity of the synchronization processing prior to the synchronization processing executed by the web browser 101.

If the checkbox 1506 is checked (enabled), the web browser 101 displays a confirmation screen (see FIG. 15B) when the synchronization processing is to be executed on the web site (web application) serving as a target of the synchronization processing. The confirmation screen may be displayed prior to the processing illustrated in FIGS. 6 and 8.

When the web browser 101 detects that a “CANCEL” button 1507 is pressed, the web browser 101 discards all of the changes set to the setting screen and closes the screen. When the web browser 101 detects that an “OK” button 1508 is pressed, the web browser 101 stores the changes set to the setting screen in the storage unit 205 (309) and closes the screen. The stored setting content is reflected on the subsequent processing executed by the web browser 101.

FIG. 15B is an example of a confirmation screen provided by the web browser 101 when the checkbox 1506 is enabled.

When the web browser 101 detects that a “NO” button 1510 is pressed, the web browser 101 adds the URL (e.g., a combination of information such as a schema, a host address, and a port) of the current web application to an exclusion list and does not execute the synchronization processing. When the web browser 101 detects that a “YES” button 1511 is pressed, the web browser 101 executes the synchronization processing illustrated in FIGS. 6 and 8.

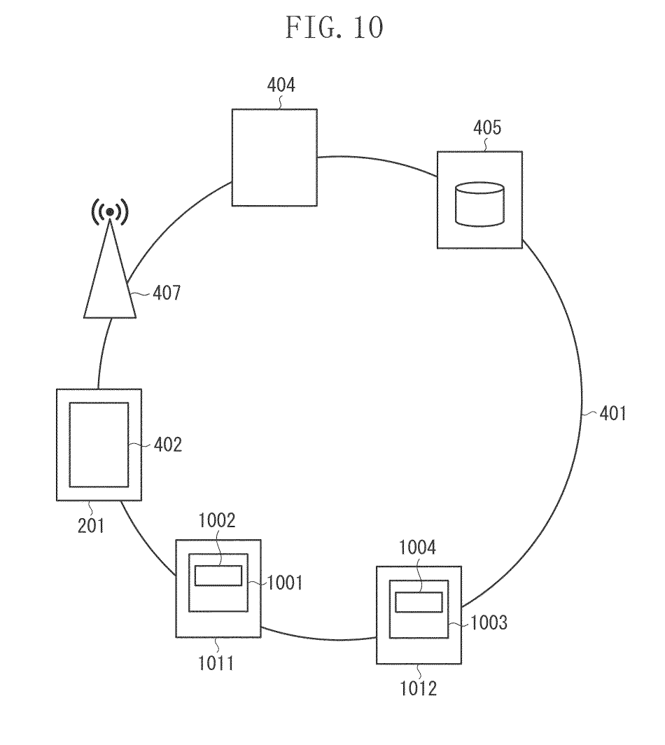

FIG. 10 is a diagram illustrating an example of a configuration of a network system according to a second exemplary embodiment. In the present exemplary embodiment, the same reference numerals are applied to the constituent elements similar to those described in the first exemplary embodiment, and description thereof will be omitted.

Information processing terminals 1011 and 1012 include hardware configurations similar to that of the information processing terminal described in the first exemplary embodiment. Web browsers 1001 and 1003 respectively operate on the information processing terminals 1011 and 1012. The web browsers 1001 and 1003 may be different web browsers developed by different vendors or may be the web browsers in different versions developed by the same vendor. Further, a storage service of the storage server 405 may be provided by a provider different from the vendor who has developed the web browsers 1001 and 1003. In addition, basic configurations of the web browsers 1001 and 1003 are the same as the configuration illustrated in FIG. 1.

Extended function modules 1002 and 1004 respectively operate on the web browsers 1001 and 1003. The extended function modules 1002 and 1004 provide a function for synchronizing data stored in the data storage units of the respective web browsers 1001 and 1003, in cooperation with the storage server 405. For example, the extended function modules 1002 and 1004 are provided by the above-described provider of the storage service as plug-in programs for extending the functions of the web browsers 1001 and 1003.

In the present exemplary embodiment, the web browser 1001 supports the WebStorage and the FileSystem API as the local storage data. On the other hand, the web browser 1003 supports the IndexedDB in addition to the WebStorage and the FileSystem API.

When the web browser supports the IndexedDB, the web application provided by the application server 404 also requests the IndexedDB to store necessary data.

The web browsers 1001 and 1003 respectively provide the extended function modules 1002 and 1004 with processing for accessing the local data via the data storage unit 108 and event processing for calling a function at the time of occurrence of an event. A method for registering the account information necessary for the extended function modules 1002 and 1004 to execute the synchronization processing in cooperation with the storage server 405 is the same as the method described in FIGS. 5A and 5B, and thus description thereof will be omitted.

Hereinafter, processing unique to the present exemplary embodiment, executed by the web browsers 1001 and 1003 will be described. The processing common to both the web browsers 1001 and 1003 will be described by taking the web browser 1001 and the extended function module 1002 as examples.

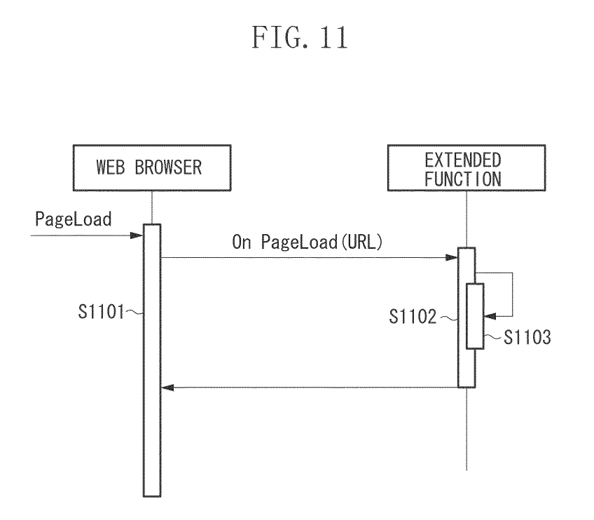

FIG. 11 is a sequence diagram illustrating processing executed by the web browser 1001 and the extended function module 1002 at the time of web page loading.

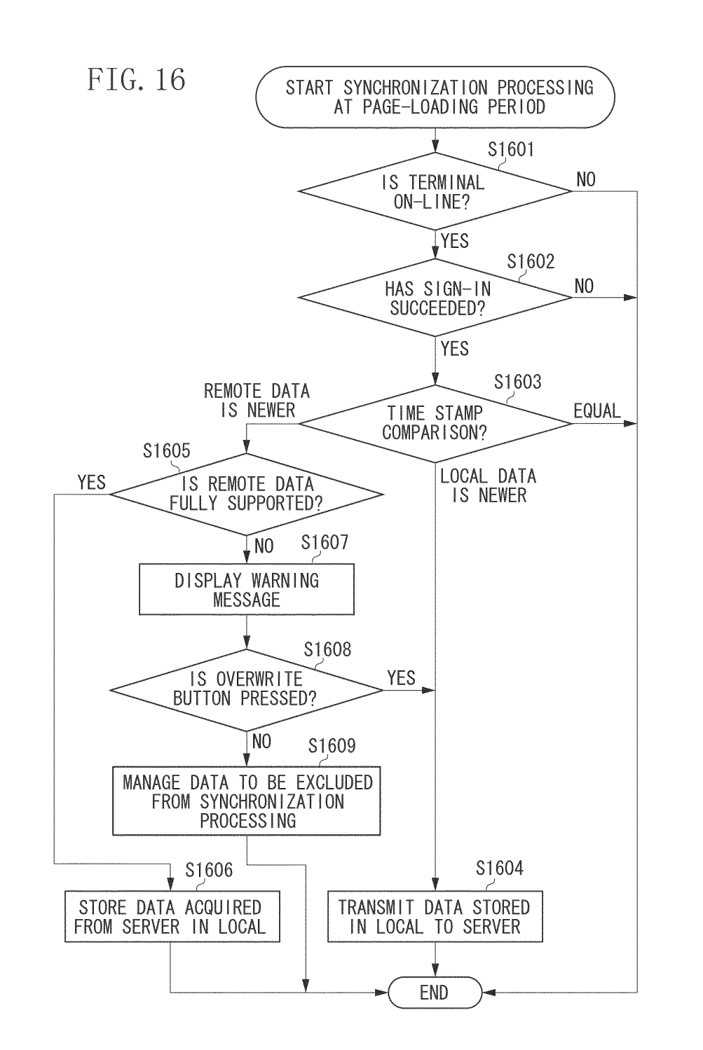

In step S1101, the web browser 1001 receives a request of web page loading processing from the user and calls the event processing at the time of page loading. This event processing is registered on the web browser 1001 by the extended function module 1002. In step S1102, the extended function module 1002 activates the event processing at the time of page loading. Then, in the event processing, the extended function module 1002 further calls the synchronization processing at the time of page loading (see FIG. 16) executed in step S1103.

FIG. 16 is a flowchart illustrating details of the synchronization processing executed in step S1103 of FIG. 11.

In steps S1601 to S1604, the extended function module 1002 executes the processing executed by the web browser 101 in the above-described steps S601 to S604 in FIG. 6. Content of the processing is the same as that described in FIG. 6. After the comparison processing executed in step S1603, if the extended function module 1002 determines that the remote data is newer than the local data or the remote data exists but the local data does not exist (“REMOTE DATA IS NEWER” in step S1603), the processing proceeds to step S1605.

In step S1605, based on the account information and the current URL, the extended function module 1002 executes the comparison processing of the remote data managed by the storage server 405 and the local data. More specifically, the extended function module 1002 checks and determines whether a type of data that is not supported by the web browser 1001 as the local storage data is included in the remote data. If the extended function module 1002 checks and determines that the type of data included in the remote data is fully supported by the web browser 1001 (YES in step S1605), the processing proceeds to step S1606. The processing in step S1606 is the same as the processing executed in step S605 in FIG. 6, and thus the description thereof will be omitted. In step S1605, if the extended function module 1002 checks and determines that the type of data that is not supported by the web browser 1001 (e.g., a value of the IndexedDB) is included in the remote data (NO in step S1605), the processing proceeds to step S1607.

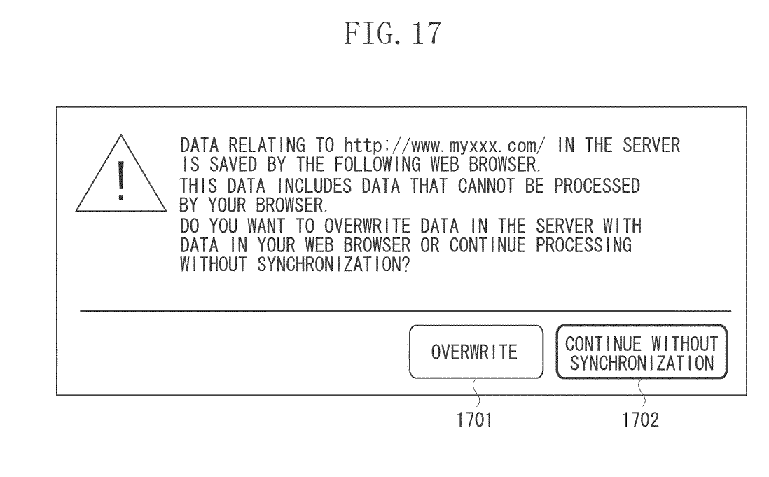

In step S1607, the extended function module 1002 provides a warning screen (see FIG. 17) via the UI 102 of the web browser 1001.

When the screen illustrated in FIG. 17 is to be displayed, the extended function module 1002 (1004) and the web browser 1001 also register the information other data on the storage server 405 when the data is to be written into the storage server 405. Specifically, the information relating to the web browser 1001 (i.e., a product name (type) and version information) and the information relating to an operation environment of the web browser 1001 (i.e., identification information of the OS or the information processing terminal) are included as the registration information.

On the warning screen of FIG. 17, the registration information relating to another web browser that has written the remote data in the storage server 405 is displayed. Further, on the warning screen, a message indicating that the remote data includes data that is not supported by the current web browser is also displayed together with a method for coping with the above condition. Further, the warning screen in FIG. 17 includes an “OVERWRITE” button 1701 and a “CONTINUE WITHOUT SYNCHRONIZATION” button 1702. In step S1608, the extended function module 1002 waits for an input from the user, and when the extended function module 1002 detects that the “OVERWRITE” button 1701 is pressed (YES in step S1608), the processing proceeds to step S1604. The processing executed in step S1604 is as described above. However, if it is determined that the local data does not exist, the extended function module 1002 transmits a request for deleting the remote data to the storage server 405. Further, if it is detected that the “CONTINUE WITHOUT SYNCHRONIZATION” button 1702 is pressed (NO in step S1608), the processing proceeds to step S1609.

In step S1609, the extended function module 1002 registers the web site (web application) corresponding to the web page currently regarded as a loading target on the web browser 1001 as a web site excluded from a target of the synchronization processing. If the web site is registered as the above, for example, the information relating to the URL of the web site is included in the list box 1502 when the web browser 1001 displays the screen illustrated in FIG. 15A. Thereafter, the extended function module 1002 ends the synchronization processing. The web browser 1001 displays the loaded web page on the UI 102 after ending the synchronization processing or in concurrent with the synchronization processing.

In the subsequent processing, if reading or writing processing with respect to the local data is requested from the web application starting from the URL excluded from a target of the synchronization processing in step S1609, the extended function module 1002 does not execute the synchronization processing relating to that request.

In addition to the above-described processing according to the present exemplary embodiment, the synchronization processing of the local data using a part of the remote data may be executed in a case where a type of data that is not supported by the web browser 1001 is included in the remote data. The data used for the above-described processing may be selected by the storage server 405 while security is taken into consideration. Further, in the processing illustrated in FIG. 16, taking the security into consideration to prevent unexpected problems from occurring, if a type of data that is not supported by the web browser 1001 is included in the remote data, the writing processing of the local data using that data is restricted.

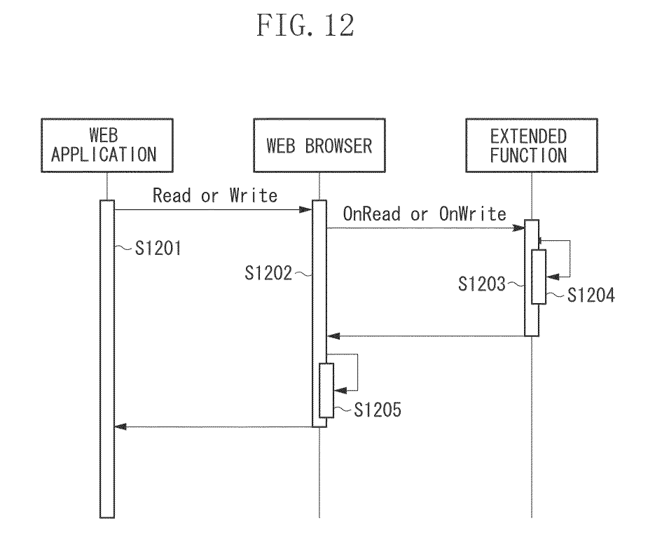

FIG. 12 is a sequence diagram illustrating processing that is to be executed when the web browser 1001 is executing the web application.

In step S1201, the web application sends a call request of reading or writing processing of the local data to the web browser 1001.

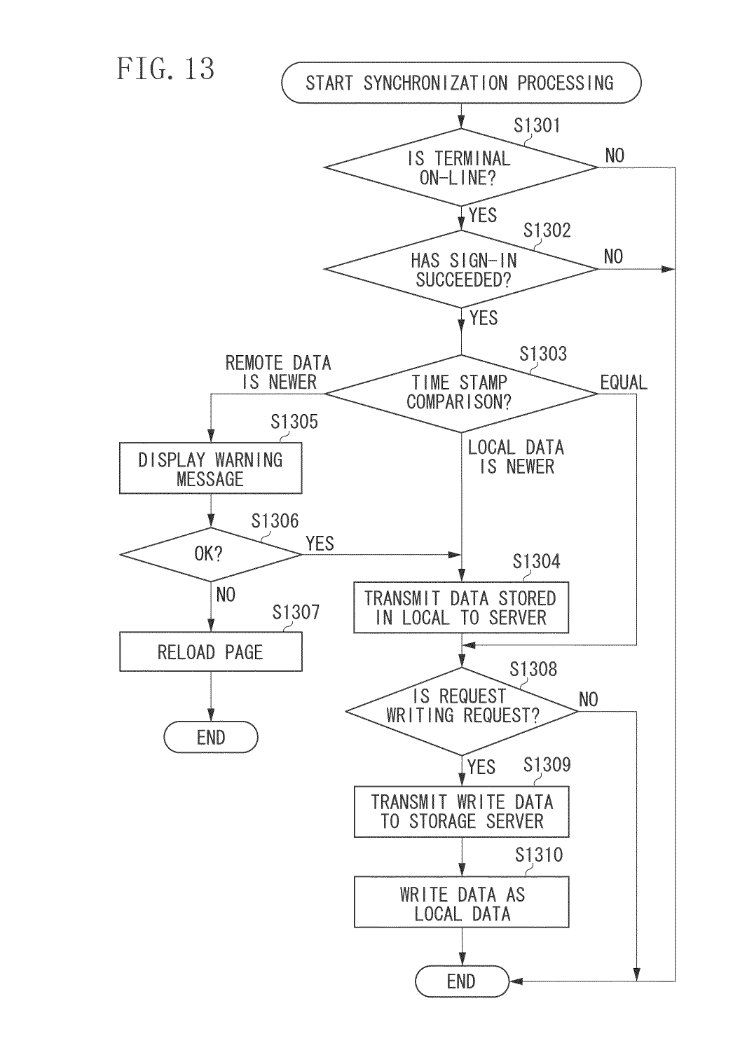

In step S1202, in response to the call request, the web browser 1001 calls the event processing previously registered by the extended function module 1002. In step S1203, the extended function module 1002 activates the event processing prior to the reading or the writing processing of the local data. Then, in the event processing, the extended function module 1002 further calls the synchronization processing (see FIG. 13) that is to be executed in step S1204.

After the extended function module 1002 ends the event processing called in step S1203, in step S1205, the web browser 1001 executes the reading or the writing processing through the data storage unit 108. Thereafter, the web browser 1001 returns the processing to the web application serving as a calling source.

FIG. 13 is a flowchart illustrating the synchronization processing executed in step S1204.

In steps S1301 and S1302, the extended function module 1002 executes the processing that is executed by the web browser 101 in steps S701 and S702 in FIG. 7. Content of the processing is the same as that described in FIG. 7. Further, in steps S1303, the extended function module 1002 executes the processing that is executed by the web browser 101 in step S801 in FIG. 8. Content of the processing is the same as that described in FIG. 8.

After the comparison processing executed in step S1303, if the extended function module 1002 determines that the update date and time of the remote data is the same as that of the local data or both the remote data and the local data do not exist (“EQUAL” in step S1303), the processing proceeds to step S1308.

After the comparison processing executed in step S1303, if the extended function module 1002 determines that the remote data is newer than the local data or the remote data exists but the local data does not exist (“REMOTE DATA IS NEWER” in step S1303), the processing proceeds to step S1305. After the comparison processing executed in step S1303, if the extended function module 1002 determines that the local data is newer than the remote data or the local data exists but the remote data does not exist (“LOCAL DATA IS NEWER” in step S1303), the processing proceeds to step S1304. In steps S1304 to S1307, the extended function module 1002 executes the processing that is executed by the web browser 101 in steps S802 to S805 in FIG. 8. Content of the processing is the same as that described in FIG. 8.

In step S1306, if the extended function module 1002 detects that the “CANCEL” button 902 is pressed on the warning screen (see FIG. 9) provided by the web browser 1001 through the UI 102 in step S1305 (NO in step S1306), the processing proceeds to step S1307. In step S1307, the extended function module 1002 reloads the web page. After the web page has been reloaded, the processing illustrated in the sequence diagram in FIG. 11 is executed instead of returning the processing to the web application serving as a calling source. Through the above processing, the local data is updated with the remote data, and a web page corresponding to the web application serving as the calling source is reconfigured by using the updated data.

In step S1308, the extended function module 1002 checks and determines whether a request from the web application is a writing request. If the request is the writing request (YES in step S1308), the processing proceeds to step S1309. If the request is not the writing request but a reading request (NO in step S1308), the extended function module 1002 ends the synchronization processing.

In steps S1309 and S1310, the extended function module 1002 executes the processing that is executed by the web browser 101 in steps S710 and S711 in FIG. 7B. Content of the processing is the same as that described in FIG. 7B.

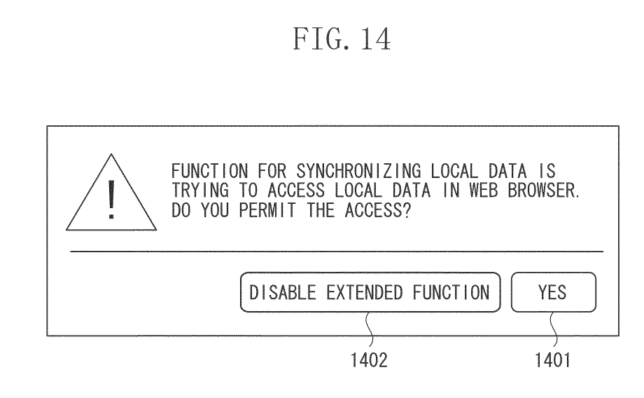

FIG. 14 is a diagram illustrating an example of a warning screen provided by the web browser 1001 through the UI 102 when the extended function module 1002 firstly accesses the local data managed by the web browser 1001.

A message indicating that the local data is to be accessed by the extended function module 1002 is displayed on the warning screen in FIG. 14. In addition, a program name of the extended function module 1002 may be also displayed together with the above message.

There may be a case where the local data stored in the data storage unit 108 includes personal information or confidential information. When the extended function module 1002 firstly calls the API for accessing the local data, the web browser 1001 displays the above warning screen to prevent the extended function module 1002 from accessing the local data without authorization of the user.

When the web browser 1001 detects that a “YES” button 1401 is pressed, the web browser 1001 stores information indicating that the extended function module 1002 has been authorized to access the local data, and continues the execution of the called API.

On the other hand, if the web browser 1001 detects that a “DISABLE EXTENDED FUNCTION” button 1402 is pressed, the web browser 1001 disables the extended function module 1002 without executing the API. Further, the web browser 1001 forcibly terminates a call for the processing corresponding to the event that causes the extended function module 1002 to access the local data, and continues the subsequent processing. For example, in the sequence diagram illustrated in FIG. 12, the warning screen illustrated in FIG. 14 is displayed while the processing of step S1204 is being executed. When the web browser 1001 detects that the user has pressed the “DISABLE EXTENDED FUNCTION” button 1402, the web browser 1001 forcibly terminates the processing of step S1203 immediately, and the processing proceeds to step S1202, at the time point where the processing in step S1203 is terminated. Therefore, the local data is not accessed by the extended function module 1002 but accessed by the web application.

### <Variation>

With respect to the web browser described in the first and the second exemplary embodiments, a size of data storable as the local data has a limitation according to the type thereof.

Even if the data can be stored in the storage service side as the remote data, the web browser may not be able to store the data as the local data because of the limitation when the synchronization processing is executed.

Therefore, if a size of the data exceeds the limitation when the web browser 101 or the extended function module 1002 acquires the remote data, the synchronization processing may be continued by deleting the local data having the older update date and time. In such a case, the web browser 101 may display a confirmation screen on the UI 102 and prompt the user to delete the local data.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-162997, filed Aug. 8, 2014, which is hereby incorporated by reference herein in its entirety.

What is claimed is:

1. An information processing terminal on which a web browser having a function for storing data requested from a web application as local data operates, the information processing terminal comprising:
a transmission unit configured to transmit at least a part of stored local data to a storage service on a network different from the web application; and
an update unit configured to update the local data by using data acquired from the storage service,
wherein the storage service manages the data transmitted by the transmission unit in association with account information and information of the web application acquired via the web browser.

2. The information processing terminal according to claim 1,
wherein the transmission unit transmits the data at least any of timings of a page-loading relating to the web application, a request of writing processing of the local data from the web application, and a request of reading processing of the local data from the web application.

3. The information processing terminal according to claim 1,
wherein the update unit updates the local data at least any of timings of a page-loading relating to the web application, a request of writing processing of the local data from the web application, and a request of reading processing of the local data from the web application.

4. The information processing terminal according to claim 1, further comprising a comparison unit configured to compare update date and time of the local data and update date and time of data managed by the storage service corresponding to the local data,
wherein, as a result of comparison, the transmission unit transmits the data in a case where the update date and time of the local data is newer than the update date and time of the data managed by the storage service, and
wherein, as a result of comparison, the update unit updates the local data by using the data acquired from the storage service in a case where the update date and time of the data managed by the storage service is newer than the update date and time of the local data.

5. The information processing terminal according to claim 4, further comprising a first providing unit configured to provide a first screen for confirming whether to update the local data by using data managed by the storage service in a case where the update date and time of the data managed by the storage service is newer than the update date and time of the local data, as a result of comparison,
wherein, according to an input through the first screen, the update unit updates the local data by using the data acquired from the storage service.

6. The information processing terminal according to claim 1, further comprising a setting unit configured to set information of a web application for which data transmission executed by the transmission unit and data update executed by the update unit are to be restricted.

7. The information processing terminal according to claim 1, further comprising a second providing unit configured to provide a second screen for confirming data transmission executed by the transmission unit.

8. The information processing terminal according to claim 1, further comprising a deletion unit configured to delete a part of data included in the stored local data in order to store data acquired from the storage service as the local data.

9. The information processing terminal according to claim 1, further comprising a third providing unit configured to provide a third screen for displaying a warning in a case where a type of data that is not supported by the web browser is included in the data acquired from the storage service.

10. The information processing terminal according to claim 1,
wherein the update unit updates the local data by using the acquired data in a case where a type of data that is not supported by the web browser is not included in the data acquired from the storage service.

11. The information processing terminal according to claim 1,
wherein the transmission unit and the update unit are realized as a plug-in extended function of the web browser.

12. The information processing terminal according to claim 11, further comprising a fourth providing unit configured to provide a fourth screen for prompting a user to make a confirmation when the extended function firstly accesses the local data.

13. The information processing terminal according to claim 1,
wherein the local data includes at least any one of data such as LocalStorage, FileSystem, and IndexedDB.

14. A method related to a web browser, comprising:
storing data requested from a web application in a predetermined region of a storage unit as local data;
transmitting at least a part of the stored local data to a storage service on a network different from the web application; and
updating the local data by using data acquired from the storage service,
wherein the storage service manages at least the part of the transmitted data in association with account information and information of the web application acquired via the web browser.

15. A computer readable storage medium on which is stored a computer program for making a computer execute a method related to a web browser, the method comprising:
storing data requested from a web application in a predetermined region of a storage unit as local data;
transmitting at least a part of the stored local data to a storage service on a network different from the web application; and
updating the local data by using data acquired from the storage service,
wherein the storage service manages at least a part of the transmitted data in association with account information and information of the web application acquired via the web browser.
